(19) United States
(12) Patent Application Publication
(10) Pub. No.: US 2018/0189767 A1
(43) Pub. Date: Jul. 5, 2018

(54) Systems and methods for utilizing payment card information with a secure biometric processor on a mobile device

(71) Applicant: FotoNation Limited, Galway (IE)

(72) Inventor: Petronel Bigioi, Galway (IE)

(73) Assignee: FotoNation Limited, Galway (IE)

(21) Appl. No.: 15/807,140

(22) Filed: Nov. 8, 2017

Related U.S. Application Data
(60) Provisional application No. 62/440,342, filed on Dec. 29, 2016.

(51) Int. Cl. G06Q 20/32; G06Q 20/40; G06Q 20/20; H04L 9/08

(52) U.S. Cl. CPC G06Q 20/3223; G06Q 20/40145; H04L 9/0891; G06Q 20/327; G06Q 20/20

(57) ABSTRACT

Systems and methods for utilizing payment card information stored on a secure biometric processor on a mobile device in accordance with various embodiments of the invention are disclosed. In one embodiment, a process for securely providing payment card information from a portable device to a payment terminal includes receiving a request for payment using a payment interface, triggering a user authentication by capturing a set of biometric information from one or more biometric sensors, calculating, using the captured set of biometric information, a match with a set of stored biometric information that is stored on a secure biometric processor in order to determine a user identifier of an authenticated user, determining a payment card out of a set of payment cards associated with the user identifier, retrieving payment card information for the determined payment card from the secure biometric processor, and transmitting the payment card information to a payment terminal.

### CROSS-REFERENCE TO RELATED APPLICATIONS

The current application claims priority to U.S. Provisional Application No. 62/440,342, filed Dec. 29, 2016, the disclosure of which is incorporated herein by reference in its entirety.

### FIELD OF THE INVENTION

The present invention relates generally to digital payment using mobile computing devices and more specifically to secure storage and access of payment card information on a mobile computing device using a secure biometric processor.

### BACKGROUND

Charge cards provide convenience and flexibility. For example, when paying for goods, services, trips or entertainment, consumers may use charge cards instead of cash. In fact, consumers may use charge cards to conduct purchase transactions even when they lack sufficient funds at the time of the transaction.

Since using charge cards is very convenient, consumers are using the cards more frequently than ever before. In fact, some consumers carry not just one charge card, but several cards. However, carrying several cards may be inconvenient, and at some point may defeat the convenience of using the cards all together.

Furthermore, carrying charge cards, just like carrying cash, may present safety and security issues since the cards may be easily stolen or misappropriated.

### SUMMARY OF THE INVENTION

Systems and methods for utilizing payment card information stored on a secure biometric processor on a mobile device in accordance with various embodiments of the invention are disclosed. In one embodiment, a process for securely providing payment card information from a portable device to a payment terminal for a financial transaction includes receiving a request for payment using a payment interface of a portable device, triggering a user authentication on the portable device by capturing a set of biometric information from one or more biometric sensors on the portable device, calculating, using the captured set of biometric information, a match with a set of stored biometric information that is stored on a secure biometric processor on the portable device using the secure biometric processor to determine a user identifier of an authenticated user, determining a payment card out of a set of one or more payment cards associated with the user identifier of the authenticated user, retrieving payment card information for the determined payment card from the secure biometric processor, and transmitting the payment card information to a payment terminal.

In a further embodiment, the set of biometric information includes a fingerprint scan.

In another embodiment, the set of biometric information includes an iris scan.

In a still further embodiment, the payment card information is encrypted and the payment terminal includes one or more decryption keys that can be used to decrypt the payment card information.

Still another embodiment also includes transmitting the payment card information to a payment card processor server.

In a yet further embodiment, the payment card information is encrypted and the payment card processor server includes one or more decryption keys that can be used to decrypt the payment card information and the decryption keys are not known to any other entity.

In yet another embodiment, each payment card is associated with a payment card identifier and retrieving payment card information for the selected payment card from the secure biometric processor includes sending a request including a payment card identifier associated with the selected payment card.

In a further embodiment again, the application processor and secure biometric processor communicate using secure communications.

In another embodiment again, the application processor and secure biometric processor each have a public key and communications are secured using each public key.

In a further additional embodiment, the process also includes receiving an encrypted baseline set of biometric information from a payment card provider server by the portable device and storing the encrypted baseline set of biometric information on the secure biometric processor.

In another additional embodiment, the payment interface is an RF ID circuitry.

In a still yet further embodiment, the process also includes determining a payment card out of a set of one or more payment cards associated with the user identifier of the authenticated user includes selecting a default payment card from the set of one or more payment cards.

In still yet another embodiment, determining a payment card out of a set of one or more payment cards associated with the user identifier of the authenticated user includes generating and displaying a list of the set of one or more payment cards on a user interface on the portable device using the application processor, and receiving a selection of one payment card of the set of one or more payment cards using the user interface.

### BRIEF DESCRIPTION OF THE DRAWINGS

FIG. 1 is a system diagram of a payment system utilizing a mobile device with a secure biometric processor in accordance with embodiments of the invention.

FIG. 2 conceptually illustrates a mobile device with a secure biometric processor in accordance with embodiments of the invention.

FIG. 3 illustrates a process for retrieving and utilizing payment card information from a secure biometric processor in a transaction in accordance with embodiments of the invention.

FIG. 4 illustrates a process for obtaining and storing payment card information to a secure biometric processor in accordance with embodiments of the invention.

FIG. 5 illustrates a process for writing biometric information of a user to a secure biometric processor in accordance with embodiments of the invention.

FIG. 6 illustrates a process for reading biometric information of a user from a secure biometric processor in accordance with embodiments of the invention

FIG. 7 illustrates a process for writing payment card information to a secure biometric processor in accordance with embodiments of the invention.

FIG. 8 illustrates a process for reading payment card information from a secure biometric processor in accordance with embodiments of the invention.

### DETAILED DESCRIPTION

Turning now to the drawings, systems and methods for utilizing payment card information stored on a secure biometric processor on a mobile device in accordance with various embodiments of the invention are illustrated. The techniques described herein include enhancing functionalities of a mobile device by configuring the portable device to obtain payment card (e.g., credit card, bank card, ATM card, etc.) information from a payment processor (e.g., credit card provider, credit card transaction processor, bank, etc.) in a secure manner, securely storing the payment card information on a hardware implemented memory chip of the portable device, and enabling the portable device to use the stored payment card information to conduct secure financial transactions. Payment card information can include, but is not limited to, identifying information of a payment card such as account number, expiration date, security code, issuing bank, and/or other information that may typically be stored on the magnetic stripe of a payment card and/or imprinted on the payment card. The chip may be initiated with payment card information received from a payment card provider or payment processor. Examples of payment card providers can include, but are not limited to, Visa™, MasterCard™, Capital One™, and similar services. In some embodiments, payment card information stored on a secure biometric processor may be modified or reinitiated by a credit card service. The received payment card information may be encrypted, and thereby secured from access by unauthorized users without the capabilities for decrypting the information.

In many embodiments, the chip is referred to as a secure biometric processor and stores biometric information of one or more users. Biometric information can be understood as referring to any of a variety of types of metrics related to human characteristics that can often be used to aid in identification of a particular user. Biometric information can include, but is not limited to, data representing a digital image or characteristics of the user's face, data representing a digital image or characteristics of the user's eye or iris, data representing a digital image or characteristics of an imprint of the user's thumb (or other digit), data representing a digital recording or characteristics of the user voice, and/or any other sample of the user's biometric characteristics.

Biometric identification data of a user may be captured by a portable device using any of a variety of techniques for capturing and storing biometric data on a secure biometric processor implemented in the device. Once the biometric information is stored on the secure biometric processor, the portable device may provide the biometric identification data to a credit card service to authenticate the user to a payment card service. The portable device may also use the biometric identification data when the user attempts to use the portable device to conduct a financial transaction using the payment card information from the secure biometric processor. A secure biometric processor implemented in a portable device may be configured to enable the portable device to securely obtain payment card information from a payment card service, securely store the payment card information on a secure biometric processor of the portable device, and/or enable use of the payment card information stored on the secure biometric processor to conduct financial transactions. As will be discussed in greater detail below, a process for retrieving payment card information from a secure biometric processor for a payment transaction may include biometric authentication of one or more biometrics of a user before the information may be transferred from the secure biometric processor. Biometric authentication may utilize a comparison with biometric data associated with the user that is stored on the secure biometric processor.

In many embodiments of the invention, payment card information is stored in encrypted form where the decryption key(s) or other cryptographic information capable of decrypting the payment card information are not present on or available to the portable device. In additional embodiments, the decryption key(s) or other cryptographic information capable of decrypting the payment card information are stored on a payment terminal. In further embodiments, the decryption key(s) or other cryptographic information capable of decrypting the payment card information are stored only on the payment card processor server.

To ensure security of payment card information, the payment card information may be encrypted in several embodiments. The encrypted payment card information can be securely stored on a memory chip of a portable device and remain in the encrypted form on the chip. In many embodiments, once the encrypted payment card information is stored on the chip, the encrypted payment card information remains encrypted and is not transmitted by the portable device to any device in unencrypted form. Since the payment card information is encrypted, it is unusable to an unauthorized user who does not have cryptographic information that can be used to decrypt the payment card information.

The presented approaches may be implemented on any of a variety of electronic mobile devices configured to receive, process and/or transmit data over a network such as the Internet. Examples of mobile devices can include, but are not limited to, mobile phones, smart phones, tablets, PDAs (personal data assistant), and/or any of a variety of other portable devices.

In several embodiments of the invention, a portable device may be used in place of a payment card to conduct financial transactions by making the encrypted payment card information stored in memory on the portable device available to, for example, a scanning device at a point of sale. The scanning device may be used to scan the encrypted charge card information presented by the portable device.

In some embodiments, a point of sale may be a computing device or terminal at a shopping center, a department store, a grocery store, a gas station, and the like, that is linked with a store register handling financial transactions. A computing device or terminal implemented as a point of sale may be equipped with a reading or scanning device, which may be configured to scan the encrypted credit card information presented by the portable device in a computer readable format, which may be in the form of a visual and/or wireless signal. For example, a computer implemented as a point of sale, may be equipped with a RFID reader or an infra-red (IR) reader, which may be used to read the encrypted credit card information presented by the portable device. In additional embodiments, a point of sale device is equipped with a near field communication (NFC) reader and the portable device provides payment card information from its secure biometric processor through an NFC tag or transmitter.

In many embodiments, the point-of-sale terminal may have access to cryptographic data, such as encryption and/or decryption keys that it can use to access the encrypted payment card information and use the decrypted payment card information to complete the purchase. In other embodiments, the point-of-sale terminal may send the payment card information in its encrypted form to the associated payment card processor or provider for verification of payment.

In several embodiments, a secure biometric processor is configured to receive and/or store encrypted payment card information for multiple payment cards associated with multiple payment card providers and/or service providers, which may include, but are not limited to, credit card service providers, retailer stores, departmental stores, banks, business enterprises, electronic gift cards providers, and other/or institutions issuing electronic cards or electronic gift cards that allow a holder of the card to purchase goods and services.

In additional embodiments, a secure biometric processor is implemented to seamlessly interface with parts and/or subsystems provided by original equipment manufacturers (OEMs), and therefore facilitating implementations of some of the various components and devices supplied by the OEMs. For example, the approach may be integrated in any type of the portable device supplied by any OEM supplier of the portable devices, and may provide the authentication capabilities to the portable device. Therefore, it may release the OEM supplier of the portable device from implementing the authentication features on the device. The approach may be used to provide some security and authentication features to the portable devices even if the devices have no such features provided by the OEM. Such device may include older models of the portable devices, such as older models of the phones that do not have authentication capabilities based on for example, biometric data. Furthermore, the approach may be easily integrated with the capabilities available via an operating system (OS) provided by companies that develop operating systems for portable devices world-wide. Secure biometric processors and different processes for using secure biometric processors to conduct transactions in accordance with various embodiments of the invention are discussed further below.

### Portable Device Implementing a Secure Biometric Processor

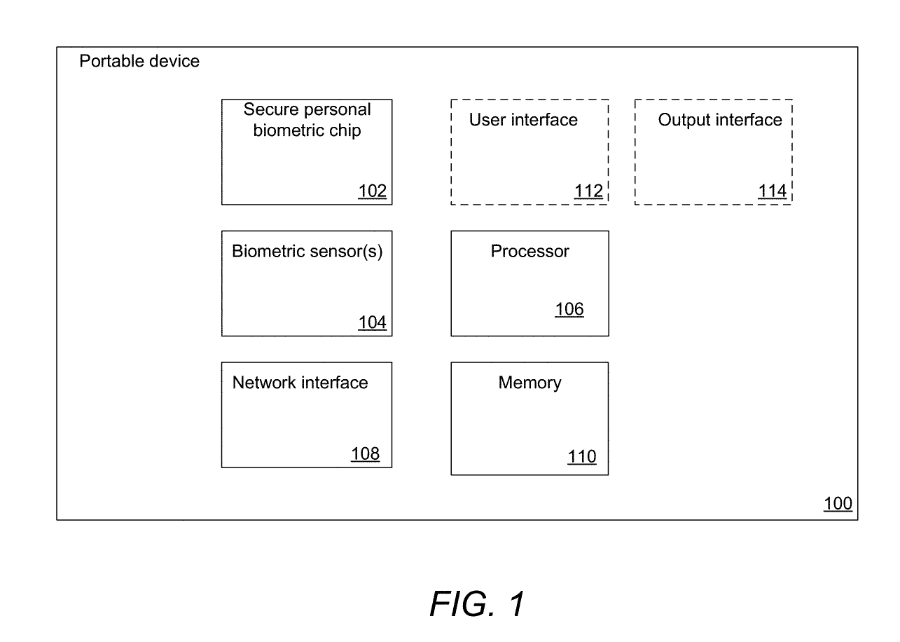

In many embodiments of the invention, a secure biometric processor storing biometric and/or payment card information is implemented on a portable device. A portable device including a secure biometric processor in accordance with several embodiments of the invention is illustrated in FIG. 1. The portable device 100 includes a secure biometric processor 102, one or more biometric sensors 104, application processor 106, network interface 108, and memory 110.

As will be discussed in greater detail further below, the secure biometric processor 102 may receive biometric information of a user and/or payment card information for storage in permanent memory, and may retrieve information to provide to an output interface 114 of the portable device. In some embodiments, biometric information is collected from one or more biometric sensors 104 by application processor 106 and provided to the secure biometric processor 102. In other embodiments, the secure biometric processor 102 obtains biometric information from the biometric sensors 104 without involving the application processor 106. Biometric sensors 104 may include, but are not limited to, a Near Infrared Reflectance (NIR) camera configured to receive NIR-type data, a Visibility (VIS) camera configured to receive VIS-type data, such as RGB data, a Serial Peripheral Interface (SPI) 206 configured to receive data, a Serial Peripheral Interface for Inter Integrated Circuit Communications (SPI/I2C) configured to receive data, such as for example, fingerprint data, a Virtual Channel Output Interface, and/or a MIPI Appliance interface.

In several embodiments of the invention, communication between the application processor 106 and secure biometric processor 102 is secured using encryption. For example, the application processor 106 and the secure biometric 102 may each be assigned a public key and communication encrypted using each public key. One skilled in the art will recognize that other similar cryptographic techniques may be utilized in accordance with various embodiments of the invention to protect communication between an application processor 106 and secure biometric processor 102 from interception.

Network interface 108 may be configured for communications via the Internet or other communications network to which portable device 100 may have access. Network communications may include sending and/or receiving biometric information and/or payment card information as will be discussed further below.

Memory 110 may include processor instructions that configure or direct the process 106 to execute processes such as those discussed further below to read and/or write biometric information and/or payment card information.

The portable device 100 may also include a user interface 112 with which a user may interact with the device by providing input and/or observing information provided on a menu or graphical interface. User interface elements can include, but are not limited to, components such as a touch screen, video screen, keyboard, touchpad, and/or similar interface components.

An interface may display names of one or more payments cards for which encrypted information is stored on secure biometric processor 102 of portable device 100. The display may be arranged as a menu, a set of icons or any other graphical form. The interface may receive input from a user indicating selection of one or the payment cards to be used and the selection communicated to secure biometric processor 102. In some embodiments, the display of the user interface is generated by the application processor 106. In several embodiments, the application processor 106 may request a listing of payment cards from the secure biometric processor 102, for example, using an application program interface (API). In other embodiments, a list of payment cards may be maintained in memory 110 and retrieved by the application processor 106 without communicating with the secure biometric processor 102.

In response to receiving the selection of a particular charge card from a menu, chip 102 may read encrypted payment card information pertaining to the selected payment card from the chip and output the encrypted information on an output interface 114. In some embodiments, a default payment card is designated for payment without necessarily utilizing input or selection by a user. In several embodiments, the output encrypted information may be scanned by any type of RFID-enabled device and/or an IR-enabled device and communicated to a point of sale terminal, such as a computer at a retailer's side. As can readily be appreciated, any of a variety of techniques can be utilized to communicate this data including (but not limited to) Near Field Communication (NFC), and/or any other appropriate wireless and/or wired connection.

While a specific architecture for a portable device with secure biometric processor is discussed above with reference to FIG. 1, one skilled in the art will recognize that any of a variety of architectures may be utilized in accordance with various embodiments of the invention as appropriate to a particular application. Biometric payment transaction systems implementing a secure biometric processor are discussed below.

### Biometric Payment Transaction Systems Implementing a Secure Biometric Processor

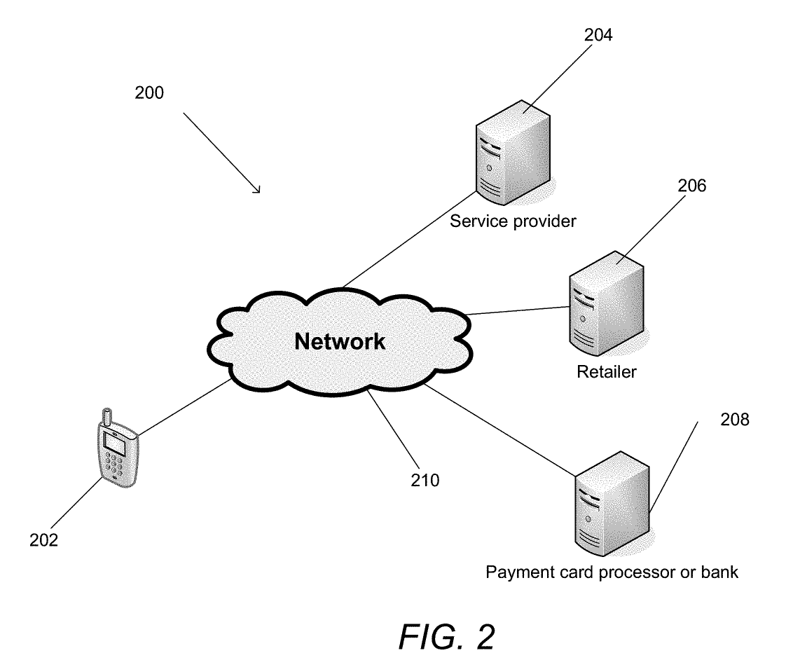

In many embodiments, a portable device including a secure biometric reader can be utilized in a biometric payment transaction system including a recipient of biometric information and/or payment card information. A biometric payment transaction system in accordance with several embodiments of the invention is illustrated in FIG. 2. The system 200 includes a portable device 202 including a secure biometric reader, service provider 204, retailer, 206, and payment card processor (or bank) 208. The devices in the system may communicate over a network 210 such as the Internet. User profiles for storing information about a user that may be stored in one or more locations in a biometric payment transaction system are discussed below.

### User Profiles

In several embodiments, a user profile is a data structure used to store information about a user. The user profile may have an associated user identifier, which may be an alphanumerical string generated to uniquely identify the profile. A user profile may be created by a payment card service provider, a chip manufacturer or an application executed on a portable device implementing a secure biometric processor. A user profile may be stored on a server maintained by the payment card service provider, on a server maintained by the chip manufacturer, and/or on a portable phone on which a secure biometric processor is implemented.

A user profile created for a user may include information about the user. The information may include the user's name, address, biometric data, the names of charge cards that the user may use, and/or similar information. For example, a user profile may include biometric data such as an image or characteristics of the user's fingerprint, or a NIR image or characteristics of the user's iris. A user profile may also include encryption and/or decryption keys.

In many embodiments of the invention, a user profile stored on a secure biometric processor includes a public section and a private section. The public section may include information such as, but not limited to, an identifier or name for the user profile, identifiers or names for payment cards, the user's address, designation of a default payment card, and/or other information. In several embodiments, information in the public section of the user profile may be read by applications on the portable device, for example, to display or communicate names for payment cards or identify which is the default payment card. The private section may include information such as, but not limited to, biometric information associated with the user, payment card information, encryption/decryption keys, and/or other sensitive information. In additional embodiments, the private section is encrypted or otherwise secured such that its information may only be accessed by the secure biometric chip and no components outside of the secure biometric chip. In some embodiments, information in the private section may also be held securely such that it is only transmitted out of the secure biometric chip after a user is authenticated using biometric information, such as in processes discussed further below.

User profiles may also be created or updated on a secure biometric processor once a portable device establishes a communications connection with a payment card service provider, such as Visa™, or similar services. The communications connection may be a secure connection established by cryptographic information known to the portable device and the charge card service provider, or using biometric data stored on the secure biometric processor for the user.

User profiles may also be created using an application executed on a portable device. For example, using the application, a user may access a service provider's website via the Internet, and launch a webpage allowing the user to request the charge card information for the user from the service provider. Then, the user may be prompted to provide valid credentials, and once the user's credentials are successfully verified, the user may initiate creating or updating the user's profile and generate a list of the charge cards that the user may use to conduct financial transactions.

In some embodiments, a portable device may be configured to execute a phone application to generate requests to access users' profiles. For example, if a user of a portable device wants to pay for his groceries using the portable device, then the user may launch a phone application on the portable device that may display a menu indicating one or more payment cards for which payment card information has been stored on a secure biometric processor implemented on the portable device. Using the menu, the user may select one of the payment cards. Upon selecting the payment card, the phone application may retrieve a payment card identifier associated with the selected payment card, and send the request along with the payment card identifier to the secure biometric processor to output encrypted payment card information corresponding to the payment card.

Notably, when the application receives the user's selection of the payment card in some embodiments, no payment card information is transmitted between the phone application and the secure biometric processor. Instead, upon receiving a user input as the user's selection of the payment card, the phone application determines a payment card identifier associated with the selected card, and uses the identifier to cause the secure biometric processor to output encrypted payment card information corresponding to the selected payment card. For security reasons, the payment card identifier may be different than the account number associated with the payment card. For example, an identifier may be generated based on the user name and the name of the charge card. In certain embodiments, a biometric authentication may be required before the user is permitted to selected a payment card or before payment card information is sent from the portable device.

In several embodiments of the invention, if a user makes personal purchases and purchases for the user's company, then at least two profiles may be created for the user on a portable device. Each profile may have a unique identifier and may be associated with different payment card information. For example, one profile may be associated with the user's personal payment card, while another profile may be associated with the user's company payment card. Hence, when the user is making a personal purchase, then the user may select a personal payment card from a menu displayed for the user on the portable device. However, if the user makes a purchase for his company, then the user may select from the menu the payment card identifier that corresponds to the user's company payment card, and by making the selection, cause the portable device to use the company payment card to start and conduct the purchase transaction.

Processes for Providing Payment Card Information from a Secure Biometric Processor for a Transaction

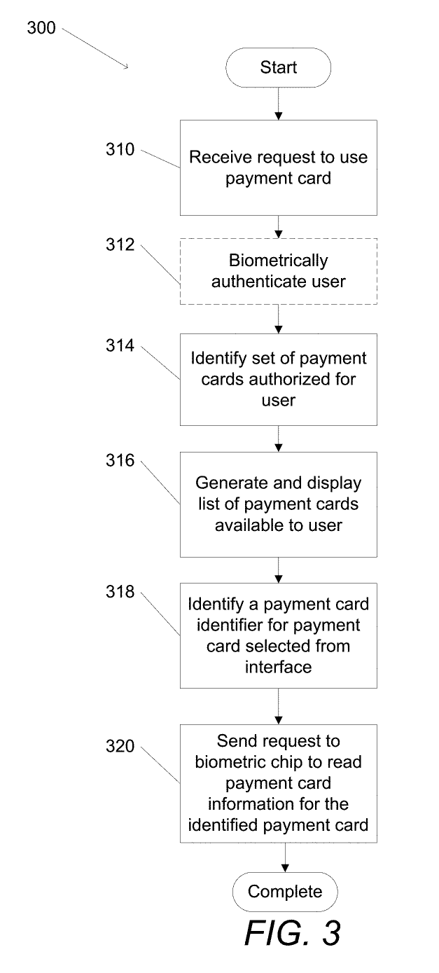

In many embodiments of the invention, a portable device with a secure biometric processor may be presented in place of a physical payment card for a payment transaction. The portable device may retrieve stored payment card information from the secure biometric processor and provide it to a point of sale device, such as a payment terminal. In many embodiments, a biometric authentication is performed on the user before providing payment card information. In several embodiments, the portable device displays one or more payment card available to a user on a user interface screen and captures the selection of one of the payment cards on the screen. A process for utilizing a portable device in a transaction in accordance with several embodiments of the invention is illustrated in FIG. 3.

The process 300 includes receiving (310) a request to utilize a payment card for a payment transaction by a portable device. In several embodiments, the request to utilize a payment card includes sending a request for payment card information from an application processor on the portable device to a secure biometric processor on the portable device. In further embodiments, the request for payment card information includes a user identifier associated with a user.

In some embodiments, one or more biometrics of the user are authenticated (312). In many embodiments, biometric authentication of a user can include any or all of: capturing biometric information using one or more biometric sensors and an application processor on the portable device, sending the biometric information to a secure biometric processor on the portable device, performing a match using the captured biometric information and previously stored biometric information on the secure biometric processor, and receiving confirmation from the secure biometric processor whether any of the captured biometric information matches any of the stored biometric information (or to what degree there is a match). In further embodiments, a biometric authentication is required only when the payment amount is over a predetermined number. A biometric match token may be passed to the payment terminal to evidence that biometric(s) were validated.

In additional embodiments of the invention, biometric authentication includes a liveliness check. With a liveness check, a biometric sensor or other component of the portable device performs an action to obtain dynamic information (e.g., a physical response) from the user to verify that static information cannot be used to give a false positive. For example, a biometric sensor configured to capture an image or characteristics of a user's iris or face could be tricked by using a photo of the user's iris or face. A liveness check could include (but is not limited to) flashing a light to provoke contraction of the iris or blinking of the eye. As can readily be appreciated, any of a variety of techniques and/or stimuli could be utilized to attempt to detect attempts to circumvent biometric authentication as appropriate to the requirements of a given application.

The process 300 includes determining (314) a set of payment cards that are available to the user. In some embodiments, one or more payment cards are associated with a user profile stored in the secure biometric processor. Information about the payment card(s) (e.g., nicknames, last four digits, or similar identifier that may be familiar to a user and/or a payment identifier for each card) can be retrieved from the secure biometric processor, for example, by providing the user identifier of the user. A message can be generated by the application processor and displayed on the user interface if the set is empty, i.e., there are no payment cards available to the user. If the set is not empty, the process 300 proceeds to generate and display (316) a list of available payment cards on the user interface.

A selection of one of the payment cards from the user interface screen is captured and the selected payment card is identified (318). In several embodiments, a payment card can be identified by an associated payment card identifier. In further embodiments, when the user or user profile only has one available payment card, the payment card can be identified by the user's user identifier.

The process 300 sends (320) a request to the secure biometric processor for payment card information associated with the identified payment card. In many embodiments of the invention, the request includes the payment card identifier and/or user identifier.

The portable device provides (322) payment card information to the payment terminal. As discussed below, payment card information may be encrypted in certain embodiments. In some embodiments of the invention, payment card information is encrypted and the payment terminal has decryption key(s) or cryptographic information that is capable of decrypting the payment card information. The payment terminal can decrypt the payment card information and use the decrypted payment card information to request a transaction with the associated payment card processor. In other embodiments, payment card information is encrypted and only the payment card processor has decryption key(s) or cryptographic information that is capable of decrypting the payment card information. The payment terminal can send a request for a transaction including the encrypted payment card information to the associated payment card processor and the payment card processor can decrypt the payment card information in the process of approving the transaction. In several embodiments, payment card information is transmitted from the portable device without using the application processor.

Many embodiments of the invention utilize a near field communication (NFC) messaging standard for transmitting and receiving information from a portable device to a payment terminal. For example, messages may utilize smart card messages application protocol data unit (APDU). An APDU send message typically includes a 4 byte header and up to 65,535 bytes of data. An APDU receive message typically includes up to 65,536 bytes of data and 2 status bytes.

Although a specific process 300 is discussed above with respect to FIG. 3, one skilled in the art will recognize that any of a variety of processes may be used for retrieving payment card information from a secure biometric processor on a portable device in a payment transaction. Processes for obtaining payment card information and storing it on a secure biometric processor are discussed below.

### Processes for Obtaining Payment Card Information for a Secure Biometric Processor

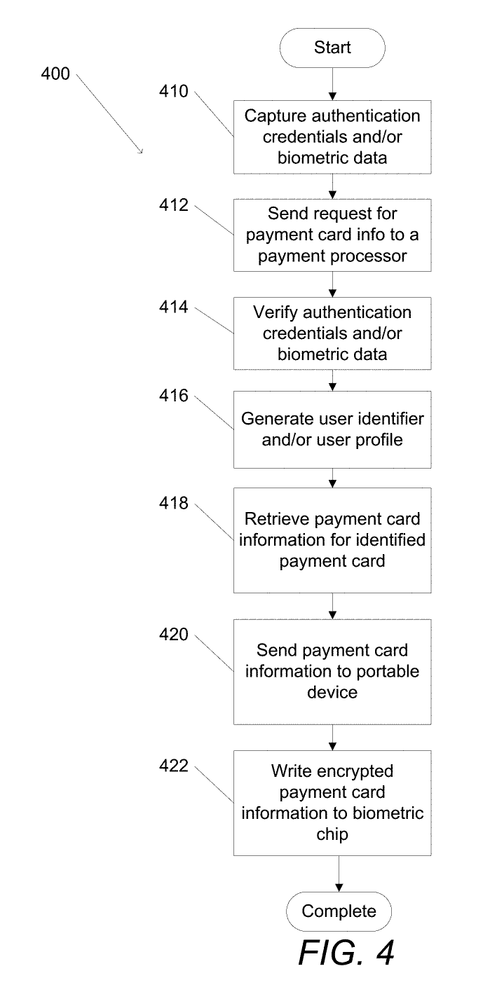

A portable device utilizing a secure biometric processor may communicate with a payment card provider's server to obtain payment card information for a payment card of a user. In several embodiments, the payment card information is encrypted. Processes for obtaining payment card information may be executed by a processor configured by an application stored in memory of a portable device. In additional embodiments, an application configuring the portable device to obtain payment card information creates a secure connection to the payment card provider server, such as by using any of a variety of end-to-end encryption protocols (e.g., Secure Sockets Layer (SSL)). A process for obtaining payment card information in accordance with several embodiments of the invention is illustrated in FIG. 4. The process 400 includes receiving (410) authentication credentials captured by the user interface and/or biometric data of a user captured by one or more biometric sensors. In many embodiments, a processor of a portable device receives the biometric data and provides it to a secure biometric processor of the portable device.

The process 400 includes sending (412) a request for payment card information from a portable device to a payment card provider server. The request can be made, for example, by an application on a portable device, such as a mobile application. The request may be sent to a uniform resource locator (URL) address, for example, of a payment card provider server. In addition, the request may be sent using Secure Sockets Layer (SSL) or other public key encryption scheme. In many embodiments, the request includes authentication credentials and/or biometric data of a user. In some embodiments, the request includes a user identifier of the user associated with the authentication credentials and/or biometric data. In further embodiments, the request includes a payment card identifier that identifies a particular payment card for which information is being requested. In several embodiments, the portable device and payment card provider server establish secure communications and send encrypted messages. A secure connection may be created using any of a variety of techniques, such as, but not limited to, SSL (Secure Sockets Layer) or other types of public key-private key cryptography or certificate validation. In further embodiments, authentication credentials and/or biometric data are verified by the portable device before sending the request for payment card information.

A payment card provider server receives the request for payment card information, extracts the authentication credentials and/or biometric data from the request, and verifies (414) the received authentication credentials and/or biometric data. If the authentication credentials or biometric data are not verified as correct, the payment card provider server may send a response to the portable device to request correct information and repeat the capture of authentication credentials and/or biometric data or capture a different type of biometric data. If the authentication credentials and/or biometric data are verified as correct, a user identifier and a user profile are generated (416) if they do not already exist (e.g., are not stored on the portable device and/or payment card provider server). The user profile may be associated with the user identifier if it is not already. The received biometric data may be associated with the user profile if it is not already.

A payment card is identified (418) using the user identifier, authentication credentials, and/or payment card identifier. Payment card information of the identified payment card is retrieved and sent to the portable device for storage on the secure biometric processor. In many embodiments, the payment card information is encrypted. In further embodiments, only the payment card provider has the cryptographic data to decrypt the payment card information. In additional embodiments, biometric information associated with the user identifier and/or user profile is sent securely from the payment card provider server to the secure biometric processor for biometric authentication.

The payment card information is sent (420) to the portable device. The payment card information is written (422) to the secure biometric processor on the portable device. In several embodiments, a biometric check is performed using locally captured biometrics (i.e., from one or more of the biometric sensors on the portable device) against the biometric information received from the payment card provider server and the payment card information is stored only if the biometrics match.

In some embodiments of the invention, the request for payment card information may contain no payment card identifier or may indicate that all payment cards are requested. The payment card provider server may respond by providing payment card information of one or more payment cards associated with the user and payment card identifiers for payment card.

Although a specific process 400 is described above with respect to FIG. 4, one skilled in the art will recognize that any of a variety of processes may be utilized to obtain and store payment card information on a secure biometric chip in accordance with embodiments of the invention. Processes for reading and writing biometric information and payment card information in accordance with embodiments of the invention are discussed below.

### Processes for Reading/Writing Biometric Information and Payment Card Information

Biometric information and/or payment card information may be written to and/or read from a secure biometric processor on a portable device as specified by a request provided to the chip in accordance with various embodiments of the invention. In several embodiments, the type of request may be identified, for example, by flags or identifiers for the type of request in a header and/or other portion of the request data.

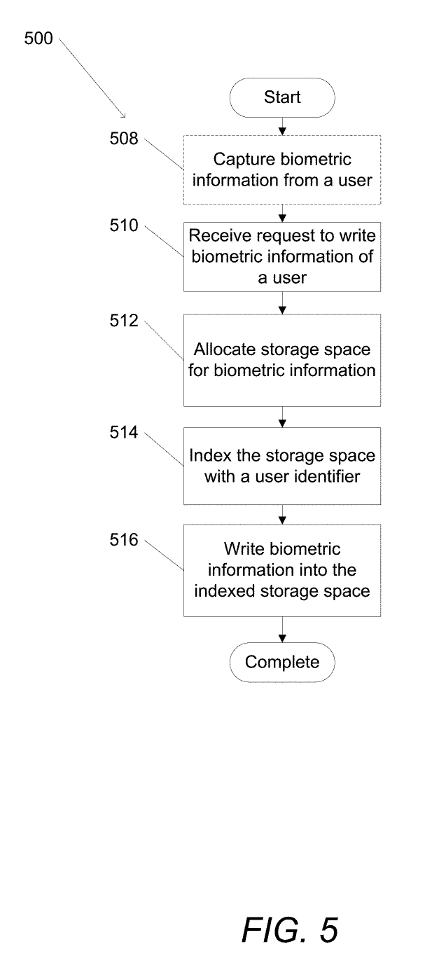

A process for writing user profile information including biometric information of a user to a secure biometric processor in accordance with embodiments of the invention is illustrated in FIG. 5. The process 500 may include capturing (508) biometric information from a user using one or more biometric sensors on a portable device. The process 500 includes receiving (510) a request to write biometric information of a user. In many embodiments, the request includes a user identifier (or a request that a new user identifier be instantiated) and biometric information of a user. Biometric information can include, but is not limited to, data representing a digital image or characteristics of the user's face, data representing a digital image or characteristics of the user's eye or iris, data representing a digital image or characteristics of an imprint of the user's thumb, data representing a digital recording or characteristics of the user's voice, and/or any other sample of the user's biometric characteristics. Storage space is allocated (512) in memory of the secure biometric processor and the storage space can be indexed (514) with the user identifier. The biometric information is written (516) into the storage space.

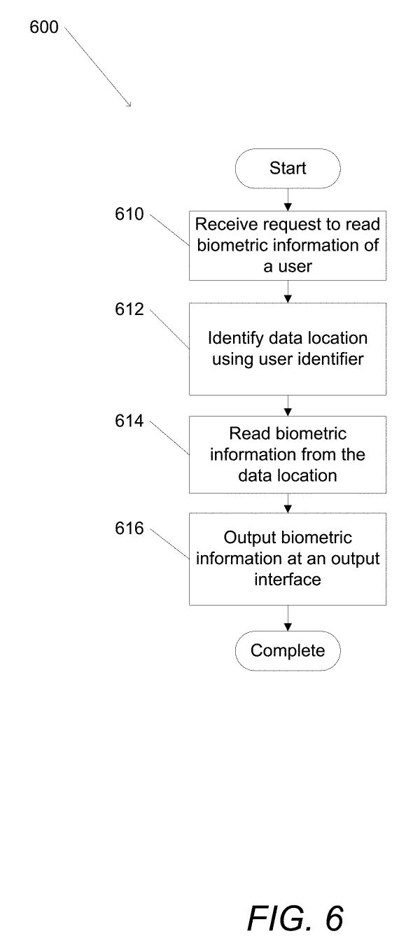

A process for reading public user profile information of a user from a secure biometric processor in accordance with embodiments of the invention is illustrated in FIG. 6. The process 600 includes receiving (610) a request to read user information of a user. In many embodiments, the request includes a user identifier. The storage space associated with the user identifier is located (612) in memory of the secure biometric processor and the public user information is read (614). The public user information is provided 616 at an output.

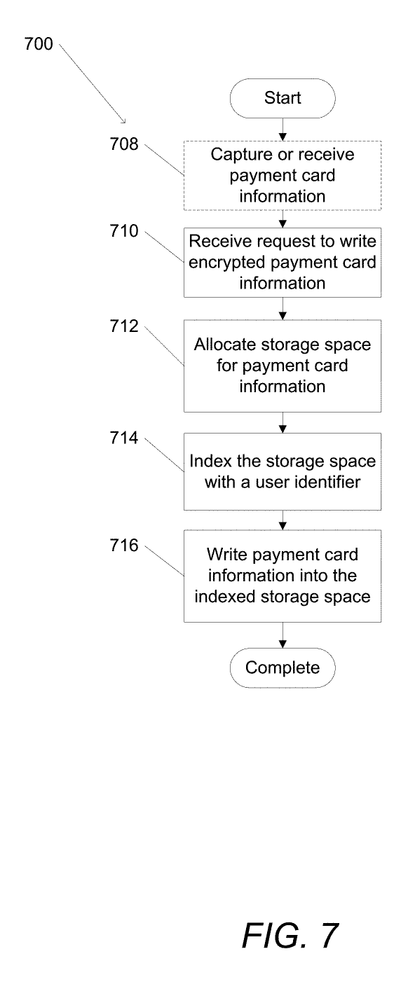

A process for writing payment card information of a payment card to a secure biometric processor in accordance with embodiments of the invention is illustrated in FIG. 7. The process 700 may include capturing (708) payment card information from a payment card or receiving encrypted payment card information through a network (e.g., from a payment card processor or provider) by a portable device. The process 700 includes receiving (710) a request to write biometric information of a user. In many embodiments, the request includes a user identifier (or a request that a new user identifier be instantiated) and payment card information of a payment card. In several embodiments, the payment card information is encrypted. Storage space is allocated (712) in memory of the secure biometric processor and the storage space is indexed (714) with the user identifier and a payment card identifier. The payment card information is written (716) into the storage space. In some embodiments where a particular user is assumed, the user identifier may be omitted from the request and/or indexing of storage space.

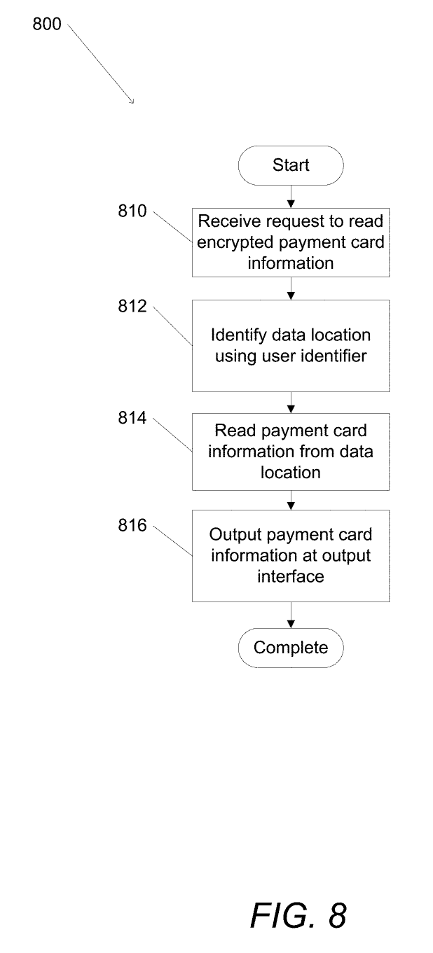

A process for reading payment card information of a payment card from a secure biometric processor in accordance with embodiments of the invention is illustrated in FIG. 8. The process 800 includes receiving (810) a request to read payment card information of a payment card. In many embodiments, the request includes a user identifier and/or a payment card identifier. The storage space associated with the user identifier and/or payment card identifier is located (812) in memory of the secure biometric processor and the payment card information is read (814). The payment card information is provided (816) at an output.

Although specific processes for writing to and reading from a secure biometric processor are discussed above with reference to FIGS. 5-8, one skilled will recognize that any of a variety of processes may be utilized in accordance with embodiments of the invention as appropriate to a particular application.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed is:

1. A process for securely providing payment card information from a portable device to a payment terminal for a financial transaction, the process comprising:
receiving a request for payment using a payment interface of a portable device;
triggering a user authentication on the portable device by capturing a set of biometric information from one or more biometric sensors on the portable device;
calculating, using the captured set of biometric information, a match with a set of stored biometric information that is stored on a secure biometric processor on the portable device using the secure biometric processor to determine a user identifier of an authenticated user;
determining a payment card out of a set of one or more payment cards associated with the user identifier of the authenticated user;
retrieving payment card information for the determined payment card from the secure biometric processor; and
transmitting the payment card information to a payment terminal.

2. The process of claim 1 wherein the set of biometric information includes a fingerprint scan.

3. The process of claim 1 wherein the set of biometric information includes an iris scan.

4. The process of claim 1 wherein the payment card information is encrypted and the payment terminal includes one or more decryption keys that can be used to decrypt the payment card information.

5. The process of claim 1 further comprising transmitting the payment card information to a payment card processor server.

6. The process of claim 5, wherein the payment card information is encrypted and the payment card processor server includes one or more decryption keys that can be used to decrypt the payment card information and the decryption keys are not known to any other entity.

7. The process of claim 1, wherein each payment card is associated with a payment card identifier and retrieving payment card information for the selected payment card from the secure biometric processor comprises sending a request comprising a payment card identifier associated with the selected payment card.

8. The process of claim 1 wherein the application processor and secure biometric processor communicate using secure communications.

9. The process of claim 8 wherein the application processor and secure biometric processor each have a public key and communications are secured using each public key.

10. The process of claim 1 further comprising receiving an encrypted baseline set of biometric information from a payment card provider server by the portable device and storing the encrypted baseline set of biometric information on the secure biometric processor.

11. The process of claim 1, wherein the payment interface is an RFID circuitry.

12. The process of claim 1, wherein determining a payment card out of a set of one or more payment cards associated with the user identifier of the authenticated user comprises selecting a default payment card from the set of one or more payment cards.

13. The process of claim 1, wherein determining a payment card out of a set of one or more payment cards associated with the user identifier of the authenticated user comprises:
generating and displaying a list of the set of one or more payment cards on a user interface on the portable device using the application processor; and
receiving a selection of one payment card of the set of one or more payment cards using the user interface.
